(19) United States
(12) Patent Application Publication
(10) Pub. No.: US 2016/0101560 A1
(43) Pub. Date: Apr. 14, 2016

(54) TOOL, TOOL STATION, THERMOFORMING SYSTEM AND METHOD FOR OPERATING A THERMOFORMING SYSTEM

(71) Applicant: KIEFEL GMBH, Freilassing (DE)

(72) Inventors: Peter KNOLL, Aainring (DE); Juergen FEIL, Laufen (DE)

(73) Assignee: KIEFEL GmbH, Freilassing (DE)

(21) Appl. No.: 14/892,292

(22) PCT Filed: May 21, 2014
(86) PCT No.: PCT/DE2014/000259

§ 371 Date: Nov. 19, 2015

(30) Foreign Application Priority Data
May 21, 2013 (DE) 10 2013 008 457.1
Feb. 4, 2014 (DE) 20 2014 000 907.4

(51) Int. Cl. B29C 51/44; B29C 51/34

(52) U.S. Cl. CPC B29C 51/44; B29C 51/34; B29L 2031/7622

(57) ABSTRACT

A tool for moulding a moulded part made of thermoplastic material and to a corresponding system and to a method. The invention relates to, in particular, the production of semi-finished products for refrigerators with a groove for receiving a seal. According to the invention, during demoulding from the undercut groove, a force acting upon the notches is braced and guided towards the residual film grid.

The invention relates to a tool, a tool station, a thermoforming station and a method for operating such a thermoforming system.

Thermoforming is widespread in daily production processes. In this process, a plastic layer is supplied, most commonly as a foil reel or as discrete plastic plates, which runs into the thermoforming system, where it is heated up to a desired temperature range and subsequently deformed. The separation of the produced single pieces can take place in the same station as the deforming process, or the separation can take place in a subsequent station.

For example, doors or interior containers for refrigerators are produced in this manner. They are thermally formed from plastic plates. In this process, a plastic film is generally drawn off the roll or plates are supplied to a transport device. In a station, the film is heated up to the thermoplastic range and then formed into the desired shape in the forming station by means of a tool.

After forming, for example, the circumferential strip of waste, often also referred to as residual grid or foil grid, is cut off along the right contours in a cutting station. Depending on the product, cutting can be divided between a longitudinally cutting unit and a transversally cutting unit, wherein system configurations with only one transversally cutting unit also exist. As a rule, in the latter configuration, the formed part is turned four times and respectively cut.

Another known method provides forming and punching in one station. In such a system, a blade is additionally provided on a tool part of the tool, most commonly at the upper tool, the blade being most often configured as a strip steel blade, wherein the strip steel blade first only minimally penetrates the plastic film during the forming process. After the forming process, during a second stroke, the blade is moved further in the vertical direction, or at any rate in the operating direction of the tool, and, in doing so, cuts the film. In order to be able to transport the product in the system together with the residual grid onward in the direction of transport through the machine, the blade is specifically designed so that it is not continuous in some areas. As a result, small notches are formed, which in practice are also referred to using the germanised English term nips, wherein the notches still allow holding the formed part sufficiently firmly in the residual grid. The formed part is then transported onward together with the residual grid. The formed part is pressed out of the residual grid in a subsequent station, most commonly in the directly following station.

The notches, i.e. the recesses in the continuous blade line are designed in accordance with the retaining force to be exerted by the notches. However, this force is not only defined by the gravity of the formed part: rather a demoulding force may also have to be taken into account in the design. For example, in the case of refrigerator doors, it is common practice to be able to insert a circumferential rubber seal. With the aid of the circumferential rubber seal, the refrigerator door closes tightly during operation of the refrigerator. In order to easily insert the door seal, refrigerator manufacturers are required to provide a circumferential groove in the door. The door seal can then be pressed into this groove, so that it is permanently retained therein. To this end, the door seal most commonly has a structure with a round cross-section, so that during insertion the round part can simply be compressed and pushed into the groove, the round part springing back again in the groove and thus locking the door seal in the groove. To this end, the groove must have a shape having a cross-section with a narrow opening toward the surface and a widening hidden below it. In practice, such a shape is often referred to as an “Omega” groove.

In order to form a groove having a small opening and a widening below it, i.e. having two undercuts, which, for the sake of simplicity, will be referred to as an “Omega” shape in the following, it is necessary, in most cases, to provide two undercut forming edges designed as protrusions on the female part of the tool, by which the undercut and subsequently the “Omega” shape are formed.

The notches in the strip steel blade are designed based on the force that is required to pull the formed part out of the undercut. Otherwise, the notches would already be torn when attempting demoulding and further transport of the formed part would be jeopardised.

In a way, the problem of a precise separation of the formed part from the residual grid is of course shifted to the subsequent station and the problem is not really solved.

The problem underlying the present invention is to provide an alternative or an improvement to the prior art.

According to a first aspect of the present invention, this problem is solved by a tool for forming a formed part of thermoplastic material, in particular from a plastic plate or sheet, wherein the tool is set up for thermoforming the work piece including thermoforming a groove with an undercut and for subsequently demoulding the work piece with the undercut groove, wherein the tool comprises a male tool and a female tool, which are set up to move away from each other in an opening direction for opening the tool, wherein a demoulding retainer is provided for demoulding the formed part out of the female tool and is set up to hold the formed part away from the female tool, wherein the tool is characterized in that a support means is provided, preferably on the female tool, which acts on the work piece in the opening direction toward the male tool.

The following terms must be explained in more detail:

As a rule, the “tool” is a two-part tool, which means that it is divided in an upper tool and a bottom tool. Both the upper tool and the bottom tool can respectively consist of several tool parts. For example, parts that are movable relative to each other can be provided both on the upper tool and for example on the bottom tool.

For the sake of simplicity, the present description refers to an upper tool and a bottom tool, because in practice the operative direction of the tool is usually vertical. However, it goes without saying that tools disposed in a different operative direction are also covered by the present invention.

In addition, is shall be explicitly pointed out that indefinite articles and numerals such as “one . . . ”, “two . . . ”, etc. must be understood, as a rule, as “at least one . . . ”, “at least two . . . ”, etc. if the respective context does not indicate that “exactly one . . . ”, “exactly two . . . 1”, etc. is meant there.

The manufacture of the “groove with an undercut” can be set up in any place of the tool. In particular, the groove can be a circumferential groove, i.e. a groove that runs around the edge of the formed part to be manufactured, at least along a substantial part of its periphery, but preferably as a closed groove along its entire periphery. The invention can be applied to a groove with one undercut, but two undercuts are preferably provided, i.e. a groove with an “Omega” shape.

In a particularly preferred embodiment, the formed part to be manufactured is the inner part of a refrigerator door and the tool is correspondingly set up for manufacturing the inner part of a refrigerator door using a thermoforming process.

The “opening direction” is usually congruent with the operative direction of the machine, but oriented in the opposite direction. As a rule, the two tool parts thus travel linearly toward each other, close and produce the formed part, and the male part, most commonly the upper tool then travels back upwards in the withdrawal direction, i.e. against the closing direction and thus the operative direction of the tool, and/or the bottom tool travels downward, and/or both tools move upward or downward in absolute terms, but in any case relative to each other with an opening motion.

The invention is applicable, irrespective of whether the upper tool and the bottom tool, i.e. the male tool and the female tool—regardless of how they are arranged—, both travel away from the formed part or whether the formed part first remains on the male part or in the female part and is demoulded after a certain delay.

The “support means” can be diverse. However, it is essential that it exert a force onto the formed part that acts against the direction of withdrawal, so that forces exerted on the groove during demoulding of the undercut are absorbed on their way to perforation, i.e. to the notches.

In case the female tool is to be pulled off around the “Omega” groove, the support means must support the formed part by means of a retention force acting against the direction in which the female tool is pulled off.

The force exerted by the support means onto the formed part acts against the force that acts on the formed part during demoulding. The resultant force resulting from the demoulding force and the force exerted in the opposite direction by the support means must be supported by the notches in the residual grid. However, the resultant force is significantly smaller than the demoulding force, so that, as opposed to the prior art, the notches need to exert only a significantly smaller force for holding the formed part in the residual grid.

In an ideal case, the tool is designed, so that no relative movement occurs between the support means and the formed part in the area of the punching line during the demoulding movement.

The geometry of the support means as such can be diverse. For example, it can be a linear support means, which runs for example along a contour of the groove to be demoulded, for example in parallel offset relation to it or at any rate running in proximity to it; in a particularly preferred embodiment, the support means is designed so that it engages with the groove. In an ideal case, the support means runs continuously or discontinuously along the entire length of the groove to be demoulded.

Finally, the support means can be used not only for reducing the demoulding force but even as a location fixation means for the formed part to be demoulded, so that the direction and the amount of displacement, stretching or bending of the formed part during demoulding can be precisely defined by means of an appropriately designed support means.

In order to be able to define the deformation of the formed part in the best possible manner, it is proposed that the support means be designed to exert a linear force on the work piece. The simplest manner in which to achieve this is that the support means be designed as a bar or frame, wherein the extension of the support means in the operative direction of the tool is adjusted to the corresponding counter-contour on the opposite tool part, i.e. ideally has the same contour. In an ideal design, the support means can then exert a retaining force onto the formed part along the entire grove, respectively fix its localization in a precisely defined manner.

In simple terms, the “demoulding retainer” shall be provided to assist a relative movement between the formed part and female tool. In doing so the formed part can be held on the male tool, but does not have to be held there. The demoulding retainer can act both from the side of the male tool and from the side of the female tool.

The “support means” is preferably disposed on the female tool. The main function of the support means is to exert a force onto the groove to be demoulded, namely from the female tool in the direction of the male tool, and/or to absorb a force, which is exerted by the female tool against the groove during demoulding, on its way to the perforated lines, i.e. to the notches.

With regard to the afore-mentioned possibility of disposing the support means on the male tool, this can be implemented for example by providing a gripper that engages with the groove from the male tool side and fixes it there on the undercuts by exerting a traction force in the direction of the male tool.

When the support means is designed to exert a linear force onto the formed part, the risk of damaging the formed part due to the exerted force is lower. Rather, the total exerted force is distributed along the line of force transmission, so that at any discrete point the tension is reduced.

The support means can have a circumferential frame. In particular, it can be a counter-component to the support means, wherein the frame can be more specifically disposed on the male tool.

It has already been explained that the tool is preferably set up to produce the formed part, so that it has notches and is joined with the residual grid. This is best implemented with a strip steel blade forming and punching tool, wherein forming is implemented in a combined tool and the plastic sheet is additionally separated, preferably punched or cut, by means of a strip steel blade, wherein notches are left, in order to maintain a connection between the formed part and the residual foil grid.

A particularly preferred embodiment of the invention provides that a demoulding pusher is disposed on the female tool, wherein the demoulding pusher is set up to follow the opening movement of the male tool relative to the female tool when the tool opens, wherein the demoulding pusher is set up to remain engaged with the work piece while the female tool moves away from the formed part while opening in the opening direction.

In short, this means that, on the one hand, the female tool has a part that demoulds the formed part when the two tool parts open relative to each other, while at the same time a demoulding pusher is provided, which does not serve for demoulding but actually excludes the point, by which it holds the formed part, from the demoulding process, by maintaining its relative position relative to the male tool, or at least maintaining its position relative to the male tool more than its position relative to the female tool.

That way, it is advantageously possible to implement a two-stage demoulding process, in which the amount of the resulting total demoulding forces can be better controlled.

It goes without saying that the relative movement of the demoulding pusher relative to the male tool does not necessarily have to be exactly zero. Rather, a less advantageous embodiment performs a small movement relative to the male tool. However, it is essential that the demoulding pusher perform a relative movement relative to the female tool and thus prevents a complete demoulding of the undercuts of the formed part.

The demoulding pusher is preferably disposed so as to grasp the groove, primarily with an undercut forming edge engaging with the undercut. When the demoulding pusher is disposed so as to grasp the groove, it can prevent a demoulding of the groove, if designed appropriately. This is particularly relevant, when it itself has formed the undercut by means of its undercut forming edge, and the undercut, which would otherwise cause demoulding, would, in the process, exert a great force onto the groove in the direction of the female tool.

In order to prevent any force exerted on the groove from acting through the formed part up to the separation line, i.e. up to the line at which the notches hold the formed and partially separated part in the residual foil grid, it is proposed that the demoulding pusher is disposed so that, with its front side, it grasps an area of the formed part adjacent to the groove, primarily between the groove and the separation line.

The demoulding pusher shall not only be designed to first, i.e. during the initial opening of the tool, shift relative to the female tool but also to subsequently open relative to the male tool toward the female tool in the opening direction and thereby to demould the undercut at the groove at least on one side, after the female tool has already moved away from the work piece.

The second demoulding step can be implemented with such a design, the amount of the forces exerted on the notches being thereby reduced.

A structurally compact and inexpensive embodiment provides that the demoulding pusher has a drive, which is set up so that, during an opening and demoulding process, it first moves the demoulding pusher relative to the female tool toward the male tool, preferably at the opening speed, and subsequently moves it back to the female tool.

In order to minimize the forces exerted during demoulding of the at least one side of the groove out of the demoulding pusher, it is proposed that a pivotable or otherwise laterally moveable evading element is disposed at the front of the demoulding pusher, wherein the evading element is preferably set up to rest on the groove during demoulding, namely with its evading direction oriented away from the groove, so that a lateral movement of the groove leads to an evasive movement of the evading element.

The more the evasive movement of the evading element is controlled as soon as the groove exerts a force during demoulding of its undercut, the more the otherwise occurring restoring force is reduced.

The demoulding pusher preferably has a demoulding pushing direction, the demoulding pushing direction being oriented parallel to the opening direction. In most cases this direction will follow a vertical spatial axis, when an upper tool and a bottom tool are used.

The upper tool is preferably the male tool.

The demoulding pusher at the female tool can have another support means grasping the formed part, said means being set up to maintain its relative position, in the opening direction, on the formed part, together with the demoulding pusher, and being for example a hydraulically driven cylinder or a plurality of such cylinders. In a structurally light construction, the demoulding pusher and the other support means are mechanically linked.

In a projection onto the plane of the material, i.e. onto the plane in which the plastic work piece was initially introduced, the demoulding pusher preferably lies between the groove and a separation means, i.e. preferably the strip steel blade in a strip steel blade forming and punching tool. In this location, the demoulding pusher can not only fulfil the function of demoulding the groove with a controlled force, but also absorb any force acting on the formed part in the direction of demoulding, before it reaches the notches.

Alternately or additionally, another support means can be provided, which lies beyond the separation means relative to the groove, i.e. in way between the designated separation edge in the plastic and the edge of the plastic.

It is particularly advantageous if the tool is a SFP tool, i.e. a combined strip steel blade forming and punching tool. When forming and punching takes place with an ideally combined tool in the same station, the cut can be oriented precisely along the course of the groove, because neither film shrinking nor transport precision issues have any influence thereon. The formed part is thus only once clamped onto a clamping frame in the combined steel strip forming and punching station and thereby fixed in its position. It is subsequently formed and ideally punched by means of the steel strip blade in the combined tool. The punching line can thereby be defined very precisely, so that the notches, which form the remaining connection with the residual grid, can also be formed very precisely. During deforming, the support means then ensure that the formed part exerts only a weak force onto the notches.

From this, it results that the aim of the preferred embodiment is to set up the tool so that it produces a formed part from the work piece that is connected with the residual foil grid by means of notches.

In particular, the demoulding pusher can form at least a part of the undercut on the tool side.

In accordance therewith, a part of the tool, ideally of the female tool that represents the undercut on the tool side, can be moved away laterally or otherwise in such a manner that the tool is less or no longer in the way of the widening part of the groove, while the groove formed in the formed part is being demoulded. For example, a tool part, that is responsible for forming the narrow neck of an “Omega” groove can be moved away laterally, for example pivoted away, so that the tool part is no longer located in the direction of demoulding of the widening part of the “Omega” groove.

The present preferred embodiment of the invention provides that a demoulding pusher is disposed in a female tool for thermoforming the groove, wherein the demoulding pusher is set up to participate in the demoulding movement of the male tool for demoulding the groove.

It must be explained that the “demoulding pusher”, which extends from the female tool to the formed part constitutes a “support means”. However, for a better understanding of the present patent application, it is referred to as a demoulding pusher.

The demoulding pusher can be provided as a single pusher, or several discrete pushers can be provided, which can respectively engage selectively or preferably linearly with the formed part.

In the present patent application, a “participation” in a movement refers to a situation where the demoulding pusher carries out the demoulding movement simultaneously or along the same path or simultaneously and along the same path as the male tool, wherein in a less advantageous embodiment of the invention, it can be sufficient if the demoulding pusher has at least one movement component that can be projected onto the demoulding direction.

The aim of a participation in the demoulding movement is to reduce or completely eliminate the consequences, in terms of demoulding, of the relative movement between the male tool and the female tool, by providing that effectively a part of the female tool follows the male tool and thus participates in its movement.

When the demoulding pusher engages with the groove with its front side, the deformation of the groove—relating to the relative movement toward the male tool—is particularly well reduced.

The “front” is that area of the demoulding pusher, which is disposed so that it at least substantially moves ahead of its pushing motion or which is at least set up to support the formed part, particularly the groove, in the pushing direction of the demoulding pusher, in order to reduce the risk of a relative motion between the groove and the male tool by exerting a force in the demoulding direction.

Alternately or in addition to an engagement of the demoulding pusher with the groove, it is proposed that the front of the demoulding pusher engages with an area of the formed part adjacent to the groove. It goes without saying that the demoulding process exerts a force onto the neck of the groove. This force continues both up to the groove and up to the adjacent area on the formed part. When the force engages with the formed part at its part adjacent to the groove, it will further improve the possibility of reducing the resulting force exerted onto the notches during demoulding.

A pivotable or otherwise laterally movable element at the front of the demoulding pusher ensures that it can be moved out of the tapering at the entrance to the groove. This is particularly the case, when the laterally movable element is set up to engage with the formed part during demoulding and when it was set up to operatively engage with the tapering at the entrance to the groove during forming.

It has already been explained that the demoulding direction of the demoulding pusher lies preferably parallel to the operative direction of the tool, wherein the arrangement can more specifically be such that an upper tool and a bottom tool are provided, so that the operative direction of the tool is vertical, the direction of the demoulding pusher also running vertically, preferably from the bottom up.

When the demoulding pusher consequently comprises a support means on a female tool, which grasps the formed part, preferably the groove, and which is set up to maintain its relative position in the demoulding direction on the formed part together with the demoulding pusher, the support means can take over the actual application of force by the demoulding pusher onto the formed part.

The projections onto the formed part in the demoulding direction of the demoulding pusher and of the support means acting on the formed part from the opposite side can cross or at least be directly adjacent. That way, the demoulding pusher and the support means acting on the formed part from the opposite side can clamp the formed part substantially between them, so that there is a minimal risk of torsion of the formed part, while both elements exert forces onto the formed part.

In the projection, the demoulding pusher preferably lies between the support means and a cutting blade or is at any rate at least partially offset from the projection of the support means in the direction of the cutting blade. That way, a very balanced force application onto the formed part can be achieved.

According to a second aspect of the present invention, the problem is solved by a tool station of a thermoforming system, more specifically for producing semi-manufactured products for refrigerators, wherein the tool station is set up with a tool as described above.

It goes without saying that the advantages of a tool or a tool station as described above also apply to an entire thermoforming system.

Lastly, it is proposed that a thermoforming station for manufacturing a thermoforming product be set up to carry out a method for producing a thermoforming product, more specifically a semi-manufactured product for a refrigerator, by using a support means during demoulding in order to reduce a necessary retention force at holding notches between the work piece and a residual foil grid, primarily by means of a tool as described above, a tool station as described above and/or a thermoforming system as mentioned above, wherein the following steps are carried out:
a. Thermoforming of a formed part with a groove having an undercut;
b. Opening the tool with a male tool and a female tool;
c. Moving a demoulding pusher forward out of the female tool during opening at the undercut in order to hold the formed part on the male tool, so that the undercut on the demoulding pusher located on one side of the groove is not demoulded; wherein, in the meantime, a second side of the groove, in particular an undercut located there, is demoulded;
d. Subsequently moving the demoulding pusher back to the female tool, so that the undercut on the first side of the groove is demoulded.

It must be explicitly pointed out that other steps may be added. Optional and advantageous features both of the method and of the devices can be gathered from the above and/or following description, if not from the patent claims.

In the following, the invention will be described in more detail based on the drawings:

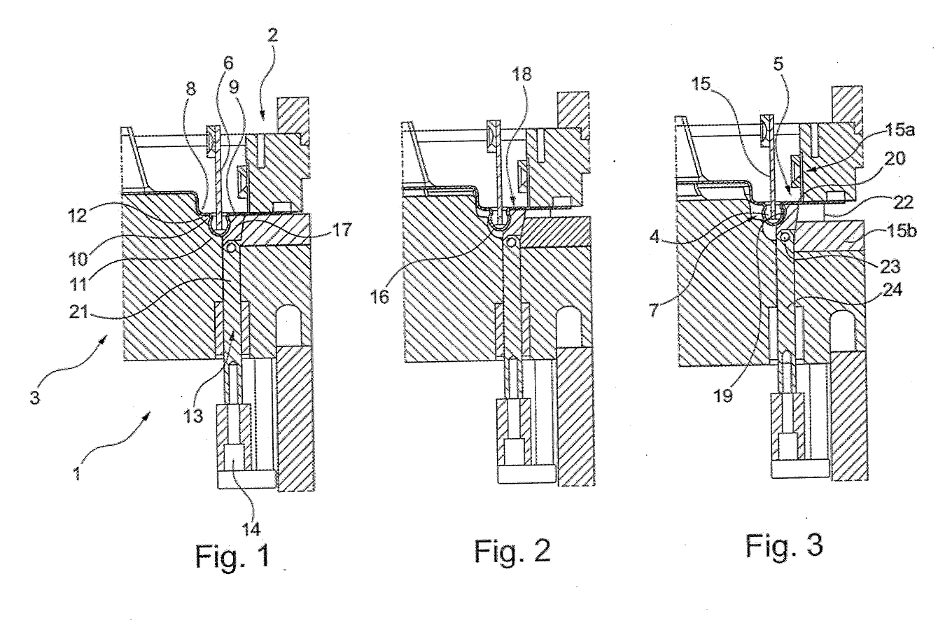

FIG. 1 schematically shows a cross-section of a detail of a combined strip steel forming and punching tool with an upper male tool and a top clamping frame, with or without a pressure bell, with a forming die and a bottom female tool.

FIG. 2 shows the detail of FIG. 1 with a female tool that has been lowered to a first degree and

FIG. 3 shows the detail of FIGS. 1 and 2 with a female tool that has been lowered further.

The combined tool 1 in the figures consists substantially of the upper male tool 2 and the bottom female tool 3.

The tool 1 is set up to produce the interior side of a refrigerator door in a thermoforming process. In the thermoforming system (not entirely shown) an unrolling station for a film sheet is followed by a heating station and then by a forming station.

The tool 1 is disposed in the forming station. The formed part 4 is given the desired shape by means of the male tool or clamping frame 2 having a forming die and of the female tool 3. In particular, a groove 7 is to be formed in the formed part 4 close to an edge 5 of the formed part 4, produced in the present example by means of a forming die 6. The groove can be referred to as a groove with an Omega shape, because it has first a constriction 10 with two undercuts and below it a widening 11, which contrasts with an otherwise continuous progression 8, 9 of the formed part 4. Such a shape is produced by two undercut edges 12 (only labelled on the left side in the figure) at the female tool 3.

It must be pointed out that the person skilled in the art would rather refer to the male tool 2 and the female tool 3 the other way around, so that the upper tool herein would be referred to as female tool and the bottom tool herein would be referred to as male tool. In the context of the present application, these designations should be understood only with regard to the Omega groove that is to be formed. It does not matter to the invention, which tool part is the male form and which is the female form with respect the formed part as a whole.

It must also be pointed out that the person skilled in the art can also refer to the tool, which is designated as the male tool herein, as a “clamping frame 2”, with or without a pressure bell.

A sealing rubber can snap into the groove 7 of the finished formed part 4, so that the circumferential seal of the door is held securely therein.

In order to implement demoulding in the present example (FIGS. 2 and 3), the male tool 2, respectively the clamping frame 2 is maintained in position, while the female tool 3 moves downward. FIG. 2 exemplarily shows a female tool 2 lowered by 4 mm and FIG. 3 a female tool 2 lowered by 8 mm.

A demoulding pusher 13, which is disposed in the female tool 3 and is driven and displaceable relative to it, is moved upward toward the male tool 2 to the same extent as the male tool 2 moves away from the female tool 3 during molding for example by lowering the female tool. To this end a hydraulic or particularly a pneumatic cylinder arrangement 14, for example, is provided and operatively connected to the same open or closed-loop control that also controls or regulates the relative stroke of the male tool 2 relative to the female tool 3. It can preferably be an electronic coupling, a mechanical coupling also being conceivable.

The demoulding pusher 13, which is disposed in the female tool is preferably actuated when the tool is closed.

When the tool is opened, a circumferential frame 15, which is provided as a support means on the male tool 2 side and is preferably disposed so that it continuously surrounds a strip steel punching blade 15a, remains stationary together with the male tool 2. When the tool is closed (FIG. 1), the plastic film, which is pulled into the tool for processing, is thus clamped between the frame 15 and a counter-frame 15b.

In order to form the groove 7, a forming slide on the male tool side, preferably the forming die 6, which is preferably formed along the entire groove 7, engages with the groove 7 and comes to rest with a rounded contact surface 16 in the groove 7 at the lowest point of the formed part 4. In addition, a positive pressure is preferably applied by the male tool 2 and/or a negative pressure by the female tool 3.

A pivoting part 17 lies directly across from the contact surface 16 on a front 18 of the demoulding pusher 13. As a support means, the pivoting part 17 has two surfaces oriented toward the male tool 2, namely a first support surface 19 and a second support surface 20. The first support surface 19 sits directly across from the contact surface 16 of the forming slide 15 and is spaced away from it only by the thickness of the formed part 4 in the groove 5. In contrast, the second support surface 20 rests next to the groove 7 against the otherwise continuous progression 9 of the formed part 4. Normally, the second support surface 20 is more important for the present invention.

In the preferred embodiment shown here, the second support surface 20 extends over at least substantially the entire width of the edge next to the groove 7 and the actual edge 5 of the formed part 4.

Like the frame 15, the demoulding pusher 13 can be designed to be continuous or discrete in its solid part 21. However, particularly good mechanical results are achieved, when the pivoting part 17 is designed so as to be continuous or when the pivoting part 17 is designed so as to be at least partially linear, so that it follows the progression of the groove 7.

At the same time or before or after the beginning of the movement, with which the demoulding pusher 13 is raised by means of the pushing arrangement 14 in such a manner that, during demoulding, it follows the relative movement of the male tool 2 relative to the female tool 3 in the direction of opening. As a result, there is no relative moment between the demoulding pusher 13, concretely the pivoting part 17 of the demoulding pusher 13 and the formed part 14 remaining at the male tool 2. Rather, the second side of the groove 7 facing the pivoting part and its undercut located there can be demoulded. Since the molded part 4 is supported by the demoulding pusher 13 between the demoulding second side of the groove 7 and the edge perforated by the blade, the forces, which, during the demoulding of the second (in the figure, left) side, act in the direction toward the female tool 3, onto the widening 11 and thus molded part 4 and which are dangerous with regard to perforation, do not arrive at the perforation or only in a greatly reduced state. Thus, the webs are not at risk of mechanical failure.

As soon as the demoulding of the second side has progressed so far that the female tool has reached or passed the broadest side of the widening 11 with its undercut forming edge, the demoulding pusher 13 can be controlled to carry out a relative moment relative to the male tool 2 and to the formed part 4 remaining on it. More specifically, in the exemplary embodiment shown here, it retracts back into the female tool 3. This leads to demoulding of the undercut on the first side of the groove 7.

In one possible design, there is no longer a support at this point between the groove 7 and the perforation, so that forces acting at the groove 7 onto the formed part 4 and oriented toward the female tool are transmitted by the formed part 4 and are able to act onto the notches at the perforations. In order to be able to also reduce or avoid these forces, a pivoting movement of the pivoting part 17 can be initiated. This can be done electronically or mechanically, or it can take place passively, in that the pivoting part 17 simply follows the demoulding forces exerted by the groove 7 onto the demoulding pusher 13, when the widening 11 of the groove 7 moves relative to and against the undercut forming edge of the female tool 3.

In the shown exemplary embodiment, another support means is provided, in addition to the demoulding pusher 13 and the frame 15, in the form of a pusher 22, in particular in the form of a pushing rod. The pusher 22 is also disposed in the female tool 3 and follows the male tool 2 during demoulding, so that the demoulding pusher 13 and the pusher 22 are lifted at the same time and to the same extent as the relative stroke of the of the male tool 2 and thus of the frame 15. The formed part 4 is thus fixed between several components, which do not move relative to each other. This results in a particularly gentle demoulding, during which the lowest possible forces are exerted onto the notches (not shown) between formed part 4 and the residual foil grid.

The pusher 22, which can also be replaced by any component with a different design, that fixes the formed part 4 on the male tool, is preferably coupled in terms of its movements with the demoulding pusher 13.

To put it another way and thus disclose other possible features:

An extension of the demoulding pusher 13 is prevented by the connection of the demoulding pusher 13 with the pushing rod, even when the former is already activated when the tool is closed. By lowering the female tool 3, wherein the clamping frame 2 remains in position, the demoulding pusher 13 travels synchronously with the relative opening speed of the tool.

After having reached its end position, the demoulding pusher 13 is brought along downward by the female tool. In doing so, the Omega undercut is forcibly demoulded on one side during the linear movement. The second side is demoulded after the pivotable pusher element on the demoulding pusher 13 has extended and pivoted away. Said element is linked to the linearly movable main part 24 of the demoulding pusher 13 via a joint 23.

A simple embodiment provides that for demoulding, the male tool, here the upper tool, remains stationary, while the female tool moves down. However, it must be explicitly pointed out that the invention can also be implemented with other absolute movements; only the relative movements between the male tool, the molded part and the demoulding pusher and the undercut forming edges of the female part are important.

1. A tool for forming a formed part of thermoplastic material, in particular from a plastic plate or sheet, wherein the tool is set up for thermoforming the work piece including thermoforming a groove with an undercut and for subsequent demoulding of the work piece with the undercut groove, wherein the tool comprises a male tool and a female tool, which is set up to move away from each other in an opening direction for opening the tool, wherein a demoulding retainer is provided for demoulding the formed part out of the female tool and is set up to hold the formed part away from the female tool, wherein a support means is provided, preferably on the female tool, which acts on the work piece in the opening direction toward the male tool.

2. The tool according to claim 1, wherein the support means is designed to exert a linear force onto the formed part.

3. The tool according to claim 2, wherein the support means has a circumferential frame.

4. The tool according to claim 1, wherein the tool is set up to produce the formed part, so that it has notches and is joined with the residual grid.

5. The tool according to claim 4, wherein the tool is a strip steel blade forming and punching tool.

6. The tool according to claim 1, wherein a demoulding pusher is disposed on the female tool, wherein the demoulding pusher is set up to follow the opening movement of the male tool relative to the female tool during opening of the tool, wherein the demoulding pusher is set up to remain engaged with the work piece while the female tool moves away from the formed part while opening in the opening direction.

7. The tool according to claim 6, wherein the demoulding pusher is preferably disposed so as to grasp the groove, primarily with an undercut forming edge.

8. The tool according to claim 6, wherein the demoulding pusher is disposed so that, with its front side, it grasps an area of the formed part adjacent to the groove, primarily between the groove and the separation line.

9. The tool according to claim 6, wherein the demoulding pusher is set up to open relative to the male tool in the opening direction and thereby to demould the undercut at the groove at least on one side, after the female tool has already moved away from the work piece.

10. The tool according to claim 9, wherein the demoulding pusher has a drive, which is set up so that, during an opening and demoulding process, it first moves the demoulding pusher relative to the female tool toward the male tool, preferably at the opening speed, and subsequently moves it back to the female tool.

11. The tool according to claim 6, wherein a pivotable or otherwise laterally moveable evading element is disposed at the front of the demoulding pusher, wherein the evading element is set up to rest on the groove during demoulding, namely with its evading direction oriented away from the groove, so that a lateral movement of the groove leads to an evasive movement of the evading element.

12. The tool according to claim 6, wherein the demoulding pusher preferably has a demoulding pushing direction, the demoulding pushing direction being oriented parallel to the opening direction.

13. The tool according to claim 6, wherein the demoulding pusher at the female tool has another support means grasping the formed part, said means being set up to maintain its relative position at the formed part in the opening direction, together with the demoulding pusher.

14. The tool according to claim 13, wherein in a projection onto the plane of the material, the demoulding pusher preferably lies between the groove and a separation means.

15. The tool according to claim 13, wherein in a projection onto a plane of the material, the additional support means lies beyond the separation means relative to the groove.

16. A tool station of thermoforming system, more specifically for producing semi-manufactured products for refrigerators with a tool according to claim 1.

17. A thermoforming system with a tool station according to claim 16.

18. A method for operating a thermoforming system for producing a thermoforming product, more specifically a semi-manufactured product for a refrigerator, by using a support means during demoulding in order to reduce a necessary holding force at holding notches between the work piece and a residual foil grid, primarily by means of a tool according to claim 1, wherein the following steps are carried out:
a. Thermoforming a formed part with a groove having an undercut;
b. Opening the tool with a male tool and a female tool;
c. Moving a demoulding pusher forward out of the female tool during opening at the undercut, in order to hold the formed part on the male tool, so that the undercut on the demoulding pusher located on one side of the groove is not demoulded; wherein, in the meantime, a second side of the groove, in particular an undercut located there, is demoulded;
d. Subsequently moving the demoulding pusher back to the female tool, so that the undercut on the first side of the groove is demoulded.
